(19) United States
(12) Patent Application Publication
(10) Pub. No.: US 2006/0142027 A1
(43) Pub. Date: Jun. 29, 2006

(54) Methods, apparatus and computer program product providing enhanced location-based services for mobile users

(75) Inventors: Govindarajan Krishnamurthi, Arlington, MA (US); Franklin Reynolds, Bedford, MA (US); Dana Pavel, Cambridge, MA (US); Dirk Trossen, Cambridge, MA (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/027,467

(22) Filed: Dec. 29, 2004

(51) Int. Cl. H04Q 7/20

(52) U.S. Cl. 455/457

(57) ABSTRACT

A mobile terminal (10) includes a transceiver (11); a user interface (10D) and a location module (10B) coupled to the transceiver and responsive to a trigger to request that a map be downloaded to the mobile terminal for storage in a memory (10C). The location module is further coupled to the user interface for displaying at least a portion of a downloaded map to a user and for prompting the user to indicate the user's location on the map. The location module is responsive to the user indicating the user's location for supplying enhanced mobile terminal location information to an application (10A) that requests mobile terminal location information.

### TECHNICAL FIELD

The presently preferred embodiments of this invention relate generally to mobile terminals, also referred to as mobile stations and mobile nodes, and associated networks and, more specifically, relate to location-based services used by mobile terminals.

### BACKGROUND

A location-based service (LBS) would be an important component of mobile services that may be offered in future mobile terminals. In providing a LBS, a client application (in the mobile terminal or in the network) would request a Position Server (PS), also referred to as the SLC in the Open Mobile Alliance (OMA) based architecture, to provide the location of the mobile terminal. In response, the PS would obtain, or helps obtain via another network node, the location coordinates of the mobile terminal, from the mobile terminal itself or from another network entity. This information would then be forwarded to the client application after translating the information into a format that is understood by the application. The user, whose location is being determined, may be, however, unaware of the granularity of the location information being transferred, and thus cannot vouch for the accuracy of the user's location information.

In general, the accuracy of the location information depends on the granularity of the information. For example, the information may point to the front entrance of a building when the user is actually located at a side entrance, or even on an upper floor of the building. This presents a problem, particularly when the user is requesting emergency services.

At the present time, most of the map-based applications for mobile devices that are known to the inventors are used for navigation and for tourist-type information. For example, one may purchase certain maps from MapQuest and download them to the mobile device. However, these conventional maps only allow for zooming in and out and for displaying certain relevant information. The maps cannot be used for converting user input into location information that can be employed for other local applications.

Local, mobile-based solutions, such as RFIDs, can be used to determine location information on the mobile terminal. However, they require appropriate infrastructure to be in place, such as RF readers, RF beacons with location information and so on. Further, the accuracy of the obtained location depends on the location infrastructure available.

As an example for external location services, the approach described by J. Cuellar et al., Geopriv Requirements, February 2004, RFC3693 (http://www/ietf.org./rfc/rfc3693.txt), defines requirements of an Internet-wide location service, hat preserves the user's privacy by demanding access control policies and that defines registration procedures for information provisioning and retrieval. Hence, approaches of this type determine the location in the network and provide the information to some application logic. Such approaches typically use radio access technologies to determine location, and a provisioning system to deliver the obtained information.

It has been proposed to add location information to a photo album, based on a user's input within a map. In the described system, the location is provided externally through a location web service, which poses the known problems in access control and provisioning. For example, the location is assumed to be provided freely, which may not be the case if certain proposed restrictions on location access and provisioning are implemented.

A method of inputting current location by clicking on a map has been used for providing a room-based current position to a home server. However, the retrieval of the map was not triggered by locally available location information.

### SUMMARY OF THE PREFERRED EMBODIMENTS

The foregoing and other problems are overcome, and other advantages are realized, in accordance with the presently preferred embodiments of this invention.

In one aspect thereof this invention provides a mobile terminal that includes a transceiver; a user interface and a location module coupled to the transceiver and responsive to a trigger to request that a map be downloaded to the mobile terminal for storage in a memory. The location module is further coupled to the user interface for displaying at least a portion of a downloaded map to a user and for prompting the user, via an appropriate user interface, to enter information related to the user's location relative to the map. The location module is responsive to the user indicating the user's location for supplying enhanced mobile terminal location information to an application that requests mobile terminal location information.

In another aspect thereof this invention provides a software product for execution by a processor of a mobile terminal that comprises instructions stored on a processor readable medium. The instructions comprise those for implementing a location module coupled to a transceiver and responsive to a trigger to request that a map be downloaded to the mobile terminal for storage in a memory. The location module is further coupled to a user interface for displaying at least a portion of a downloaded map to a user and for prompting the user to indicate the user's location on the map.

In a still further aspect thereof this invention provides a method to operate a mobile terminal having a transceiver, the method comprising, in response to a trigger, operating a location module of the mobile terminal to request that a map be downloaded to the mobile terminal; displaying at least a portion of a downloaded map to a user; prompting the user to provide information related to the user's location relative to the map and using the provided information to enhance user location information that is provided to an application.

In another aspect of this invention a method is provided to operate a mobile terminal having a transceiver. The method includes, in response to a request from a location-based application, operating a location module of the mobile terminal to request, via the transceiver, that a position server provide information that is descriptive of a location of the mobile terminal; in response to receiving the information, displaying at least a portion of a corresponding map to a user; prompting the user to provide additional information related to the user's location relative to the map and using the provided information to enhance user location information that is provided to the location-based application.

In a still further aspect thereofthis invention provides a mobile terminal that comprises a wireless transceiver and a user interface coupled to a data processor operating under control of a stored program. The mobile station further comprises a location module coupled to a location based services (LBS) application and responsive to the LBS application to request, via the transceiver, that a network-based position server provide information that is descriptive of a location of the mobile terminal. The location module is further operative, in response to receiving the information, to present at least a portion of the information to a user via the user interface and to prompt the user to provide additional information related to the user's location. The location module is also responsive to the user providing additional information to supply enhanced user location information to the location-based application. The LBS application maybe resident in the mobile terminal, or it may external to the mobile terminal.

In a still further aspect thereof this invention provides a mobile terminal having a transceiver, a user interface and means, coupled to the transceiver and the user interface and responsive to a trigger, for requesting that map-related information be downloaded to the mobile terminal for storage in a memory. The requesting means is further operable for causing said user interface to present at least a portion of downloaded map information to a user and to prompt the user to enter information related to the user's location relative to the presented map information for generating enhanced mobile terminal location information for use by at least one of a resident and a non-resident application.

In another, still further aspect thereof this invention provides a mobile terminal that includes a wireless transceiver and user interface means. The mobile terminal further includes location means coupled to a location-based services (LBS) application and responsive to the LBS application for requesting, via the wireless transceiver, that a network-based position server provide information that is descriptive of a location of the mobile terminal. The location means is operative in response to receiving the information for presenting at least a portion of the information to a user via the user interface means and for prompting the user, via the user interface means, to provide additional information related to the user's location. The location means is responsive to the user providing additional information for supplying enhanced user location information to the location-based application.

### BRIEF DESCRIPTION OF THE DRAWINGS

The foregoing and other aspects of the presently preferred embodiments of this invention are made more evident in the following Detailed Description of the Preferred Embodiments, when read in conjunction with the attached Drawing Figures, wherein:

FIG. 1 is a block diagram that shows the overall architecture in accordance with first embodiments of this invention;

FIG. 2 shows an IP-based location architecture that also comprises a part of the system architecture shown in FIG. 1;

FIG. 3 shows steps and message flows executed by the location service and associated components shown in FIGS. 1 and 2 in accordance with a first embodiment of this invention; and

FIG. 4 shows steps and message flows executed by the location service and associated components shown in FIGS. 1 and 2 in accordance with a second embodiment of this invention.

### DETAILED DESCRIPTION OF THE PREFERRED EMBODIMENTS

In accordance with one aspect of this invention a mechanism is provided whereby a user has the option to modify location information. The modification may entail, by example, adding detail to or deleting detail from the location information. The modified location information may be sent to the final recipient (e.g., the application that uses the location information) of the message for added clarity, along with location information sent by the network, thereby facilitating the recipient of the message in obtaining a more accurate representation of the sender's location. It is assumed for the purposes of describing the presently preferred embodiments of this invention that the modified information is converted or re-converted into a form that is understood by the client application.

In a preferred, but non-limiting embodiment a simple methodology that uses Short Message Service (SMS) messaging, or an Internet Protocol (IP) based message, or any other type of message in another format over some kind of a software interface, provides the user, whose location information is being verified, with the ability to update the information that is being provided by the network.

In certain presently preferred embodiments of this invention a mechanism is provided whereby a user whose location is being provided is enabled to edit the location information and to forward the potentially modified information to the application/client that is requesting the location information (requester).

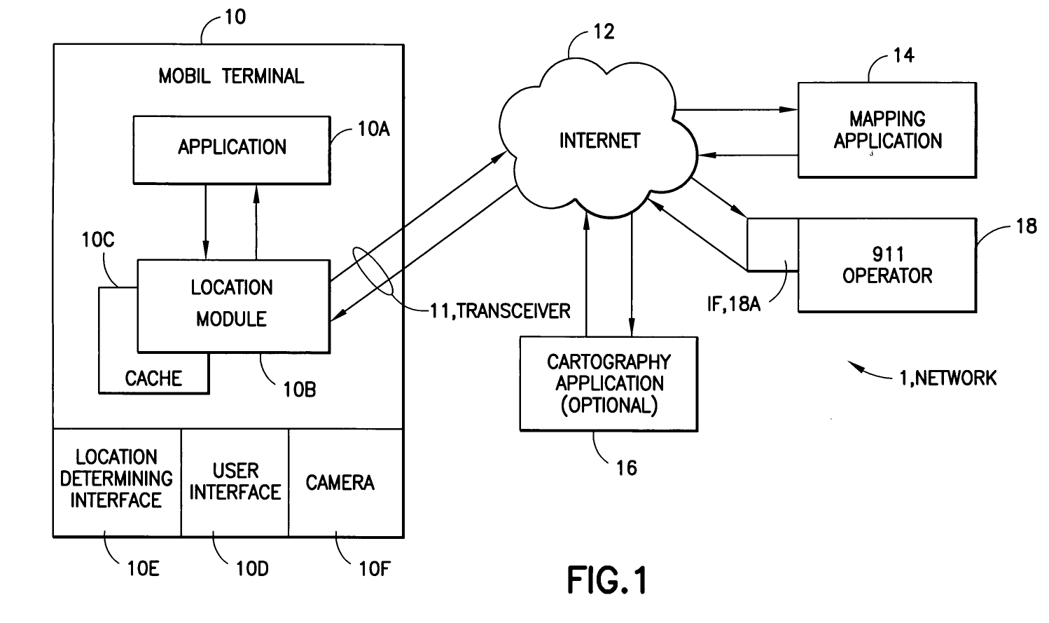

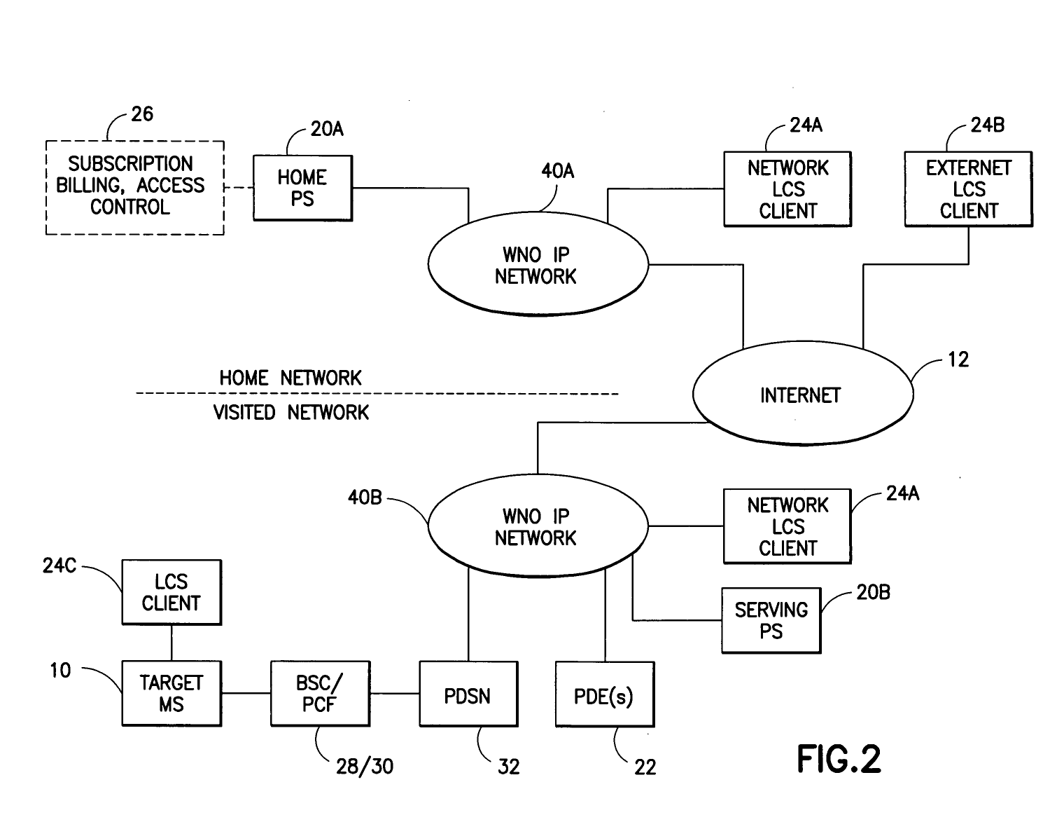

Reference is made first to FIG. 1 for describing a presently preferred embodiment of this invention. It should be appreciated that FIG. 1 will typically contain at least some of the network elements and functionality shown in FIG. 2 (and described below) for enabling the operation of the location-based application(s) and service(s). FIG. 1 presents a non-limiting embodiment where an application that provides the location-based service resides in a mobile terminal 10.

Referring to FIG. 1, the following entities are assumed to be present in a network 1. There is assumed to be at least one mobile terminal 10, also referred to herein as a mobile node, on which a user can run an application 10A that uses location information to provide service for some purpose. The mobile terminal 10 also includes a location module (LM) 10B that runs on the mobile terminal 10, and that is used by the application 10A to obtain a user's location information according to non-limiting embodiments of this invention. The LM 10B may implement or operate with a local memory, also referred to herein as a cache 10C, that is capable of storing map information associated with particular technology-specific location information, e.g., associated with the cell ID location information in a GSM-type system. The mobile terminal 10 may be or may include a cellular telephone having a transceiver generally indicated as 11 in FIG. 1, and connectivity is provided via a wireless link with the Internet 12 through a cellular network operator (not shown). In some embodiments the wireless connectivity to the Internet 12 may be provided via a short range IR or RF (e.g., BluetoothTM) link through a wireless local area network (WLAN) node (not shown), and the transceiver 11 is provided accordingly. The mobile terminal 10 may be incorporated within another device, such as a portable computer, or a gaming device, or an Internet appliance, and thus should be viewed broadly as being or forming a part of a number of different types of devices and equipment.

A mapping application 14 translates location information, including technology-specific location information such as cell ID and Global Positioning System (GPS)-like coordinates of the location information. The mapping application 14 maybe provided by the network operator, but may also be operated through a third party that has appropriate knowledge to perform the required location mapping. The mapping application 14 may thus be considered to be or to include a service that aids in translating location coordinates into human understandable form (e.g., into text or vector maps). The mapping application 14 may also be implemented to have a cartography application that is co-located with the mapping application 14, and in some embodiments in accordance with this invention there may be both a separate cartography application 16 and the mapping application 14 available for location-based service applications.

As explained previously, the cartography application 16, which may be assumed to be a recipient of mobile terminal 10 location information from the mapping application 14, may be used to provide, as non-limiting examples, a vicinity vector map of the user-provided location information (which has already been transformed in GPS-like coordinates) through the action ofthe mapping application 14. In other embodiments the translation can be made to, as non-limiting examples, text, zip code, a map and combinations thereof.

Note that although the term GPS-like is employed for the transformed location information, it is possible to use some other format, so long as the selected format is understood by the cartography application 16. One non-limiting example of an alternative format includes street and number/zip code/city information. In the following description the use of GPS-like coordinates is assumed as an input for the cartography application 16, without restricting the applicability of the invention to other formats.

The ensuing description assumes, strictly for convenience and not as a limitation upon the practice of this invention, the use of cell ID, such as in GSM, with respect to the available location information within the mobile terminal 10. However, on other embodiments other types of information can be used, such as information from RFIDs, to obtain location information locally, coupled with the use of an appropriate mapping application to map these IDs onto location information of the premises where the RFIDs are deployed. In general, it may be desirable to use the most accurate location information that is available. Thus, in some cases the cell ID information may be available, but it may not be used in favor of some other available, and more accurate, location information

For completeness, reference may also be had to FIG. 2, which shows an IP-based location architecture such as one being standardized for a 3GPP2-type network. In FIG. 2 it is assumed that a home network wireless network operator (WNO) IP network 40A is coupled to a visited WNO IP network 40B via the Internet 12. A Position Server (PS) 20 is assumed to be the network entity that co-ordinates the gathering of the geographic position information of a target mobile terminal 10 to requesting entities, and in FIG. 1 is shown as the mapping application 14. The PS in the home network of the mobile terminal 10 is referred to as the Home PS 20A, and the PS in the network in which the mobile terminal 10 is currently roaming is referred to as the Serving PS 20B. The PS 20 performs functions such as some or all of accepting and responding to the requests for a location estimate of a target mobile terminal 10, authentication, service authorization, privacy control, billing and the allocation of Position Determining Entity (PDE) 22 resources for the sake of positioning. The PDE 22 communicates with the PS 20 to determine the geographic position of the target mobile terminal 10, possibly based on input data provided by the mobile terminal 10. An LCS Client 24 is a software or hardware entity that interacts with an LCS server for the purpose of obtaining location information about a specific mobile terminal 10. The LCS client 24 is the application that provides Location-Based Services (LBS) to the mobile terminal 10, and may reside in the network as the network LCS client 24A, or as an external LCS client 24B, or in the mobile terminal 10 as the internal LCS client 24C. The subscription, billing access control function 26 is a part of (as an example) a CDMA2000 access network, and the Base Station Controller 28 is an entity that provides control and management for one or more Base Transceiver Stations (also referred to as Base Stations (not shown)). A Packet Control Function (PCF) 30 can be co-located with the BSC 28 and provides interfaces to an access gateway to support bearer streams between the mobile terminal 10 and the IP network. The Packet Data Service Node (PDSN) 32 provides an interface to the IP core network to the CDMA2000 Radio Access Network (RAN).,

Referring again to FIG. 1, when the application 10A, residing in the mobile terminal 10, wishes to locate the user to provide a particular service (a location-based service provided by the location-based application 10A), the application 10A contacts the location module LM 10B which then contacts, using for example IP or circuit-switched connections, the PS 20A in the home network, or the PS 20B in a network that the mobile terminal 10 is currently roaming in. After ensuring that the mobile terminal 10 (if the request originates in the mobile terminal 10) or the external application is authenticated/authorized and a framework is established for the mobile terminal 10 to possibly be billed for the location transaction, the PS 20A or 20B obtains the location coordinates of the mobile terminal 10. For this purpose, the PS 20A or 20B can request the mobile terminal 10 to provide GPS or other types of location coordinates to the PDE 22, or it may use physical layer criteria from cellular network base stations to determine the location of the mobile terminal 10 with some degree of granularity. These location coordinates, then, are mapped into human readable form (possibly by the Position Determining Entity 22 or via some other external mapping or cartographic application such as the nodes 14 and 16, and this information is provided to either the PS 20A or 20B or directly to the mobile terminal 10.

In one embodiment of the invention (for example, when the application providing the location based service is in the network, such as the network LCS client 24A shown in FIG. 2) the initial recipient of the location co-ordinates of the mobile terminal 10, in the network, maybe the PS 20A or 20B (for example, from a PDE 22). Location information may then be transferred to the software/hardware interface that is connected to the network based LBS application in the LCS client 24A. However, in this embodiment of the invention, the PS 20A or 20B forwards the location information (either in human understandable form or as raw location coordinates) to the mobile terminal 10. This information can be sent as an SMS message to the user of the mobile terminal 10. The term SMS is used herein without any loss of generality, as the same effect can be achieved using IP messaging, or by any other dedicated circuit switched messaging. The SMS specification currently permits a SMS message to be sent to the mobile terminal 10 even when the user is currently on a phone call. In an emergency, this may be a desirable feature. A unique session ID and code is preferably added to the SMS message to allow the receiving application 10A at the mobile terminal 10 to recognize the SMS as being one associated with the embodiments of this invention. The recipient's phone number or IP address are preferably also included in the SMS message, if the initial request for the location of the mobile terminal 10 is made by a network entity. The destination address of the SMS message could be the requestor of the location information.

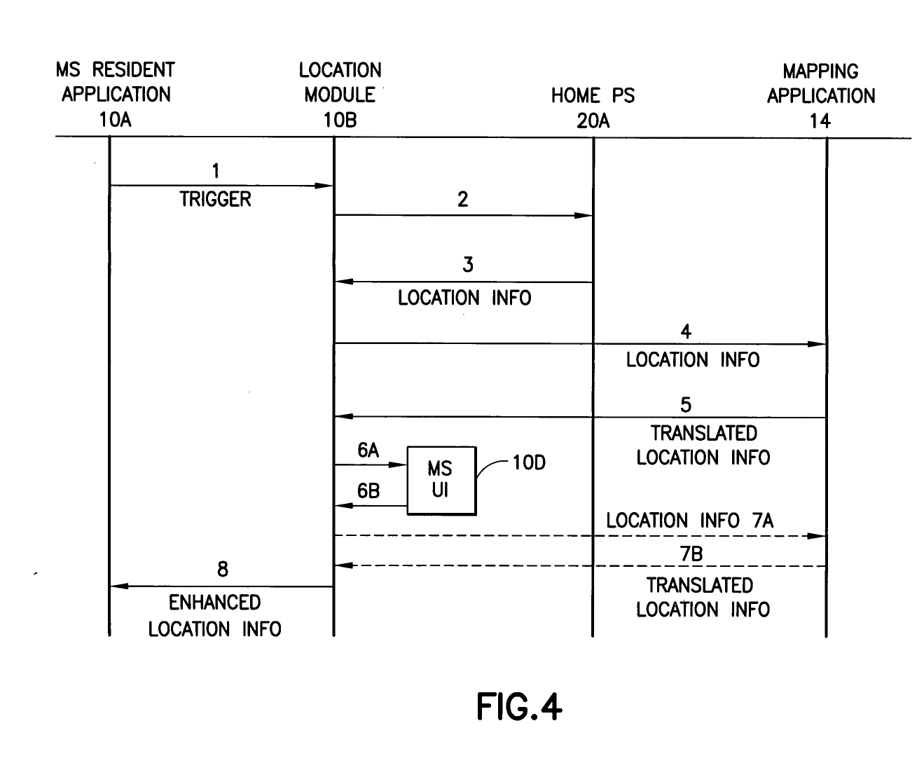

Once this information is received at the mobile terminal 10 a dedicated application, such as the location module 10B, presents the received SMS (or an appropriate IP-based message) to the user via the user interface (UI) 10D of the mobile terminal 10. If the information received by the location module 10B is raw location information then it is preferably first converted to human understandable form before presenting this information to the user. As will be made more apparent during the discussion of FIG. 4, for the purpose of translation the location module 10B may contact the mapping application 14. The user may edit the presented location information to reflect the user's current location as accurately as possible. When the user is satisfied with the location information, the user then sends or pushes the modified located information, as enhanced location information, back to the LM 10B via the user interface 10D. The LM 10B then translates this information into an appropriate format and either sends the modified information, via an IP message, or an SMS, or a circuit switched message back to the PS 20. The PS 20 then forwards the modified information in an appropriate format to the application that consumes the location information. In another embodiment, and if the LBS application resides in the mobile terminal 10 (FIG. 1 as the application 10A), then the interface that receives this information presents this information to the user via the user interface 10D (in human understandable format). Once the user is satisfied with the location information, the interface forwards this information to the Location Module 10B, which then forwards this information to the mobile terminal resident application 10A.

As one non-limiting example, in an emergency situation the user in a high rise building may edit the location information to add floor and room or cubicle information, and then send the edited location information to a 911 operator.

It may be the case that the mobile terminal 10 has other ways of determining its location, such as by using BluetoothTM, or WLAN access point IDs, or even specialized location hardware such as one knows as “Crickets” (see, for example, The Cricket Location-Support System, Nissanka B. Priyantha, Anit Chakraborty, and Hari Balakrishnan, Proc. of the Sixth Annual ACM International Conference on Mobile Computing and Networking (MOBICOM), August 2000.)

Location information that can be ascertained from one or more of these interfaces 10E may be added to the original determined location information and sent to the recipient. The modified location-containing message may also include videoiaudid data if the underlying protocol allows such a transfer, and assuming that there is sufficient bandwidth available for enabling such extended services.

The teachings in accordance with this invention can also be used even for the case where the mobile terminal 10 does not include the location determining interface 10E, such as GPS capability.

For example, the user, with a non-GPS enabled mobile terminal 10, may wish to travel to the nearest restaurant from his or her current location. Using this invention the user can edit the information that is sent to the mapping application 14, such as by including cross street information, and thus receive more specific and accurate directions to the restaurant. Without this capability, the location of the mobile terminal 10 might be associated with the location of the base station that the mobile terminal 10 is currently attached to (for cell ID-based location determination). As a result, the directions would be given so as to originate from the location of the base station, or possibly from the center of the city that is covered by the base station. However, the base station and the mobile terminal 10 may be several kilometers apart.

It is noted that the use of the embodiments of this invention may be activated at the time of registration of the mobile terminal 10 service with the network operator.

In the preferred embodiments of this invention (such as in the system architecture depicted in FIG. 2), when the location information of the mobile terminal 10 is used by an application that is network resident, such as the network LCS client 24A, the LM 10B is embodied as a software module that operates to interpret the location information within the initial received SMS (or other type of message, such as an IP or SS7 message) from the PS 20A or 20B, or any other network based node, to create a new message (after converting it into human understandable form if needed) based on this initial location information, to present the new message to the user and to permit the user to edit the new message using the UI 10D. Assuming the user modifies the location information, the LM 10B forwards the modified location information, after possibly transforming the information into another format that is understood by the entity (PS 20A, 20B or the network based client 24A) receiving this information, to the PS 20A or 20B, or to the network-based LCS client 24A. If the PS 20A or 20B receives this information, then the PS 20A or 20B forwards this information to the network-based LCS client 24A, again after possibly modifying the format of the information to a format that is understandable by the software/hardware at the network based LCS client 24A.

In one non-limiting embodiment of this invention (FIG. 1), when the location information of the mobile terminal 10 is used by the mobile terminal resident application 10A to provide service to the user, the LM 10B can be embodied as a software module that operates to interpret the location information within the initial received SMS (or other type of message such as a dedicated IP or SS7 message), create a new message (after converting it into human readable or recognizable form, if needed) based on this initial location information, present it to the user, and permit the user to edit the new message using the UI 10D. If the user modifies the location information, the modified information is received by LM 10B via the UI 10D. The LM 10B then converts this information to the format that is understood by the application 10A and forwards the information to the application 10A. The application 10A then provides the necessary location-based service to the user.

In one non-limiting embodiment the UI 10D enables the user to speak the location, which is then recognized and transformed to data (which may be in the form of text) that is used in the new location message.

In another non-limiting embodiment, and assuming that there is sufficient bandwidth, the UI 10D enables the user to add an image or images to the new location message, such as if the mobile terminal 10 includes an image capture device, such as a digital camera 10F, or to add voice or some other audio information to the new location message.

If the user does not wish to modify the location information, then a message is sent to the LM 10B to use the current location information. If the message with the modified location information is addressed to the location information recipient, such as the mapping application 14, then in the case where the user does not make any modifications to the message, the message can be simply dropped (if the network based mapping application 14 has already received a copy of the unmodified location information of the mobile terminal 10 from the PS 20A or 20B). If this is not the case, the LM 10B informs the Home PS 20A to forward the originally calculated location information to the mapping application 14. If there is no modification of the location information by the user and the requestor is the mobile terminal-resident application 10A, then the LM 10B just forwards the original location information in the appropriate format to the application 10A.

In another embodiment, the LM 10B may activate other interfaces that may be concurrently available on the mobile terminal 10, such as a BluetoothTM or a WLAN interface, and attempt to retrieve location information stored on such devices and also add this supplemental information to the new location message.

The mapping application that translates the mobile's location information into human understandable format (vector map, text etc) can be implemented as a software/hardware module on the PS/PDE 20/22, or any other dedicated element in the network or even in the mobile terminal 10. The transport protocol for the messages described below may be, as non-limiting examples, IP, or SS7 depending on whether the PS 20A or 20B is present in an IP network or an SS7 network.

In one non-limiting embodiment of this invention, after mapping the location information into a human-understandable form, the mapping application 14 forwards this information in a message to the mobile terminal 10. A unique session ID is preferably added to this message. The mapping application 14 also saves a context for this message. The saved context contains at least the session ID, the recipient (or requestor) address and other details that may be necessary to deliver the message to the recipient. Using the location module 10B and the UI 10D, the user is permitted to modify the location information appropriately. The LM 10B then sends the possibly modified information back to the PS 20A (when the LCS client is 24A). On receiving the location information the Home PS 20A retrieves the address of the recipient from the stored context based on the session ID and forwards the, possibly modified, location information of the mobile terminal 10 to the LCS client 24A using an appropriate message format. This embodiment of the invention is particularly well suited for use in non-emergency situations, as the PS 20A preferably waits for a certain period of time for the mobile terminal 10 to respond with the modified location information. After a timeout the PS 20A may again attempt to send the message to the mobile terminal 10. If the mobile terminal 10 does not respond then the PS 20A sends the location information, as originally determined and unmodified at the mobile terminal 10, to the recipient of the message 24A.

A further non-limiting embodiment of this invention is particularly useful in emergency applications. In this embodiment, after determining the location of the mobile terminal 10 to a certain level of granularity, the Home PS 20A forwards the location information to the recipient, which may be a 911 operator 18. This information may be already in a human understandable format, or it may be in some other format. If the information is in a non-human understandable format, then it is preferably the responsibility of the software/hardware interface (IF) 18A with the 911 operator 18 to translate the location information into an appropriate format. The Home PS 20A also creates session state at the as described in the previous embodiment and sends the location information to the LM 10B on the mobile terminal 10. Based on how the LM 10B is configured and the content of the received message, the LM 10B may then respond directly to the recipient (i.e., to the 911 operator 18 in this example), or it may respond back to the Home PS 20A. If the mobile terminal 10 responds to the Home PS 20A, the Home PS 20A forwards the information to the 911 operator 18 as described previously.

There are a number of advantages that can be obtained by the use of these embodiments of the invention. As non-limiting examples, the advantages include an ability to support both circuit switched and IP-based core networks, an ability to use SMS/MMS based added location information, requiring minimal or no modifications to the core network, and an ability to operate with either 3GPP or more advanced 3GPP2-based networks.

The following two non-limiting examples are provided to illustrate how the user-determined location information may be used as a replacement for, or as a supplement to, the more complex (network-based) location information.

In the first example, consider a photo album that is created on a multimedia-enabled mobile terminal 10, such as one having the camera 10F. The user may wish to enrich the pure photographic information by accompanying details, such as the location where the photograph was taken, a name for the photograph, objects appearing in the photograph and so on. In order to obtain the user's location, a local service is invoked on the mobile terminal 10 to display a map of the surrounding area and to prompt the user to indicate, such as by clicking, on the map in order to determine the user's current location. The local service then uses the available information to map the user's input onto coordinates or other location information, e.g., “State House”, and deliver the determined location back to the photo album, which in turn adds the information to the photograph.

In a second example, consider a person who enters a building. Assume that the building is entirely covered by a WAN, such as 2G or 3G. Assume further that cell ID information would not provide location information within the building. However, the person still wishes to be able to determine his/her location within the building in order to invoke location-based services. For this purpose the currently available cell ID information is used to obtain map information of the cell's vicinity. After the person indicates that he or she is within the building, e.g., by clicking on the map, an internal building server is contacted in order to obtain a vector map of the building, assuming that the user is authorized to obtain such information. The last available GPS coordinates, which were valid upon entering the building, may be used to determine that the user has entered the building so that the internal server would be contacted. After obtaining the building's vector map, the user can click within this map in order to determine his/her location for obtaining customized services, available resources, and other location-based services within the building.

Aspects of this invention provide for making a determination of the user's location information within the mobile terminal 10 through input by the mobile user, via the user interface 10D, after initially providing information of the user's surrounding information by the network operator (or a third party provider). In this embodiment of the invention the information provided to the user can comprise a vector map, which is displayed on the mobile terminal 10, awaiting the user's input for location determination.

An aspect of this invention provides for obtaining a user-determined location on a mobile terminal 10 through locally cached maps that are obtained based on locally available location information, such as the cell ID in GSM.

A further aspect of this invention is that the LM 10B may provide locally available location information to the external mapping application 14 that returns a map, preferably a vector map. As employed herein a vector map is a map that allows for zooming in or out of the map, such as the area covered by the current cell and its vicinity. The request for a map download may be triggered by events such as the mobile terminal 10 entering a new cell. The LM 10B preferably stores the provided map in the internal cache 10C for later retrieval, in order to optimize response time and traffic over the wireless link. Alternatively, the map download may be requested only as it is needed (on-demand), although the user may perceive the delay in downloading the map, depending on the network conditions.

If, at some point in time, an application requires location information, the LM 10B is invoked, which in turn retrieves the vector map of the surrounding area (e.g., based on the current cell ID in GSM, or using GPS coordinates), either through information available in the local cache 10C or through retrieving the relevant information online through the mapping application 14.

The LM 10B renders the appropriate vector map for display and prompts the user via the UI 10D for the user's current location such as by, for example, pointing at the location within the displayed map (assuming that the UI 10D includes, for example, a touch sensitive screen or some other pointing-enabling UI). The user input is then translated into appropriate location information, based on the vector information of the map. The determined, and possibly user-modified, location information is then provided to the invoking application, e.g., for annotation or other purposes.

As was noted above, the embodiments of this invention allow for obtaining map information prior to an actual request from an application. This pre-fetching can be triggered, for example and not by way of limitation, by entering a new location area, e.g., by detecting a change in the cell ID, or by fetching a map or maps associated with certain cells due to some anticipation logic in the LM 10B (such as one based on movement detection). In this latter case the downloaded map may be one based on a predicted next cell ID based on a current cell ID, and on a speed and direction of movement of the mobile terminal 10.

Referring to FIG. 4, upon receiving such a trigger from a mobile resident LBS application, 10A (message 1), the LM 10B contacts (message 2) a location coordinator node in the network (the Home PS 20A, for example, in an IP-based location services environment). The Home PS 20A then determines the raw location coordinates of the mobile terminal 10, possibly with the aid of a PDE. The location coordinates (location information, message 3) are then transferred to the mobile terminal 10 (in either raw format, or in human understandable format, or in a format that is requested by the application 10A), and are received by the LM10B. The LM 10B contacts the mapping application 14 if the information is not in human understandable format and forwards the raw location information to the mapping application 14 (message 4) which then translates the location information into human understandable form and sends it back to the MS 10 (message 5). The translated location information is routed to the LM 10B who then presents it to the user via the UI 10D (shown as 6A). The user may then correct, supplement or otherwise modify the presented location information as desired and then forward the edited location information as enhanced location information to LM 10B (shown as 6B). If the LM 10B receives modified (enhanced) location information it may convert the location information into application 10A understandable format (by itself or by contacting another node such as the mapping application, shown as optional messages 7A, 7B), and then forwards the location information to the application 10A. The LBS application 10A receives the enhanced location information and then provides the appropriate service via some interface (e.g., audio, video, display, etc) to the user.

As supplementary information, a map request may include location information that is locally available at the mobile terminal 10, such as the cell ID, as well as optional information such as the diameter of the vicinity of interest in miles or kilometers and/or neighbor information for indicating a number of neighboring cells that are to be included in the returned map.

The mapping application 14 uses the provided information to derive the mapping to actual coordinates of a certain area, associated with this location information. For example, the provided cell ID is mapped onto the appropriate base station's coordinates, or a specific RFID tag number is mapped onto an appropriate location, such as a building.

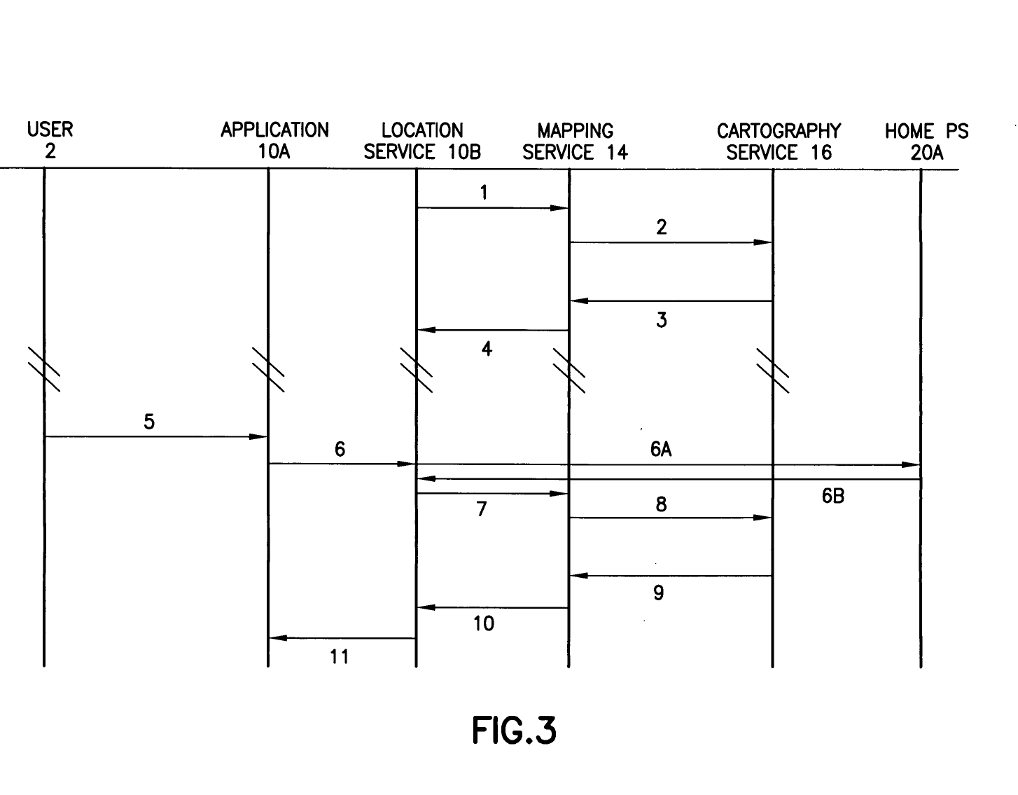

For a case where the mapping application 14 does not perform the functions of the cartography application 16, the derived mobile terminal 10 coordinates are then included in the cartography request that is sent by the mapping application 14 to the cartography application 16 (message 2 in FIG. 3). Optional supplemental information in this request may include the diameter of the requested surroundings of the point of interest, e.g., expressed in meters or kilometers.

Note that the exact format of the cartography request depends on the exact nature of the cartography application 16. However, protocols such as HTTP or SOAP (Simple Object Access Protocol) may be employed.

In general, the mapping application 14 may be or include any functionality whose output may be a map, or information that can be used to derive a map, or text, or any suitable information that may or may not be human-readable and understandable.

In a non-limiting embodiment the cartography application 16 generates a vector map of the received coordinates' surrounding and sends the vector map back to the mapping application 14 (message 3 in FIG. 3), which in turn sends the vector map to the LM 10B (message 4 in FIG. 3).

Upon reception of the vector map information with message 4 in FIG. 3, the Location Module 10B stores the received information in the internal cache 10C with appropriate information, such as the cell ID that is associated with the vector map.

At some point in time, the mobile user 2 or some other internal or external entity initiates an action with the application 10A that requires location information as an input (step 5 in FIG. 3). The application 10A in turn requests the user's current location from the LM 10B (message 6), that in turn makes a request of the Home PS 20A of the user (message 6A in FIG. 3), which is returned to the LM 10B as message 6B.

The LM 10B examines the cache 10C for the availability of the appropriate map information by comparing the available information in the cache 10C with the current locally available location information, e.g., with the current cell ID. If the appropriate map information is found to be locally available in the cache 10C, the LM 10B uses the information found in the cache 10C directly to proceed with map rendering (see below). Otherwise, the LM 10B retrieves the map information similar to messages 1, 2, 3, and 4 as messages 7, 8, 9, and 10 in FIG. 3. Upon reception of the map information from the mapping application 14, the LM 10B stores the received map information together with the appropriate location information, e.g., the cell ID, in the local cache 10C for use during possible later requests.

Upon retrieval of the map (either locally through the cache 10C or by execution of steps 7, 8, 9, and 10), the LM 10B renders the vector map, displays the map on the screen of the user interface 10D of the mobile terminal 10, and prompts for the user to input the user's location relative to the map. The user input may be by any one or more of the following non-limiting examples of input types: designating (e.g., clicking on) a particular point in the map and requesting to zoom in or out of the surroundings of this point; clicking on a particular point in the map and requesting to move the map to the left/right or up/down; and clicking on a particular point in the map and confirming this point as the user's current location. The first two types of user input are used to re-render the vector map with the changed parameters. Other map operations (such as tooltips of points of interests) may also be used.

Upon receiving the user input, the input is translated into appropriate location information, based on the vector information of the map, and the LM 10B provides the derived location information back to the application 10A (step 11 in FIG. 3).

It should be noted that the above-described LM 10B may be integrated as a building block for applications and services, such as at the application level. The LM 10B building block may be linked (dynamically) with applications that desire to use the location service. The mapping application 14 may be realized as an application running in an external party, which is assumed to have a trust relationship with both the mobile user and the network operator. The mapping application 14 may also be provided directly through a network operator. The cartography application 16, if a separate entity from the mapping application 14, may be provided through any of a number of private or public existing services, such as MapQuest.

In contrast to the previous map-related techniques discussed earlier, the embodiments of this invention use locally available information, such as the cell ID, which is disclosed by the mobile terminal 10 itself, therefore meeting the challenges of future regulations.

The embodiments of this invention allow for pre-fetching and caching of map information, and also for retrieving map information of a certain diameter. The pre-fetching may be triggered based on entering a new cell in the access network, or by operation of some anticipation logic. The caching of map data reduces the traffic on wireless link and improves the response time of the system, as the map information is available in the local cache 10C when needed.

The embodiments of this invention further provide the functionality of location determination through a user's input as an independent location service that is application-independent.

The embodiments of this invention enable a user's location to be determined without having a specific location service in place within the network (or by a third party) by using locally available information, such as the cell ID, in conjunction with user-entered information to refine (reduce the granularity) of the cell ID information. For example, by the user entering cross-street information via the user interface 10D the user's location within a cell area can be localized to within a few meters.

The embodiments of this invention also improve the privacy of the user's location information by using locally available information, e.g., cell IDs.

The architecture of the invention, namely the provisioning of the location information through a location module on the mobile terminal 10, allows for transparently replacing the location determination by another location service that does not rely on the method of the invention. With this building block approach made possible by the use of the embodiments of this invention the LM 10B may be deployed as an alternative until more accurate location services are available, or the LM 10B may be used concurrently with another location determining service (e.g., an external service) in order to avoid using the external service without the necessity of doing so (e.g., for privacy reasons).

The embodiments of this invention use available information and functionality for implementing the different entities in the architecture, such as cell IDs and map information (e.g., through services such as MapQuest).

While described in the context of the mobile terminal architecture shown primarily in FIG. 1, it can be appreciated that the LM 10B may actually be implemented as a program executable by a processor of the mobile terminal 10. As such, the teachings of this invention pertain as well to computer programs and computer program products, including those stored in computer readable medium such as fixed and rotating magnetic memories, as well as in semiconductor memory as a few examples.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. As but some examples, the use of other similar or equivalent messaging formats and flows, map types and map download trigger criterion may be attempted by those skilled in the art. Further by example, it is within the scope of the teachings of this invention to inquire of the user about the user's confidence regarding the provided location. If the confidence is below some fixed or variable threshold, the location can still be requested through “conventional” means, such as an external location service, if desired by the application that initially requested the location information. However, all such and similar modifications of the teachings of this invention will still fall within the scope of the embodiments of this invention.

Furthermore, some of the features of the preferred embodiments of this invention maybe used to advantage without the corresponding use of other features. As such, the foregoing description should be considered as merely illustrative of the principles, teachings and embodiments of this invention, and not in limitation thereof.

What is claimed is:

1. A mobile terminal, comprising:
a transceiver;
a user interface; and
a location module coupled to the transceiver and responsive to a trigger to request that a map be downloaded to the mobile terminal for storage in a memory, and further coupled to said user interface for displaying at least a portion of a downloaded map to a user and for prompting the user to enter information related to the user's location relative to the map.

2. A mobile terminal as in claim 1, said location module being responsive to the user entering the information related to the user's location for supplying enhanced mobile terminal location information to an application that requests mobile terminal location information.

3. A mobile terminal as in claim 1, where said trigger comprises a change in cell ID.

4. A mobile terminal as in claim 1, where said trigger comprises an output of anticipation logic.

5. A mobile terminal as in claim 1, where the map is downloaded via the transceiver from a mapping application that transforms between technology-specific location information and other location information.

6. A mobile terminal as in claim 1, where the map is downloaded from a mapping application that transforms between cell ID location information and Global Positioning System (GPS)-like coordinate information.

7. A mobile terminal as in claim 1, where the map comprises a vector map.

8. A mobile terminal as in claim 1, where the map is downloaded from a mapping application that requests the map from a cartography application.

9. A mobile terminal as in claim 1, where the map is downloaded over the Internet from a mapping application that requests the map over the Internet from a cartography application.

10. A mobile terminal as in claim 1, where the map is downloaded from a mapping application based on a current cell ID of the mobile terminal.

11. A mobile terminal as in claim 1, where the map is downloaded from a mapping application based on a predicted cell ID of the mobile terminal.

12. A mobile terminal as in claim 1, where the map is downloaded from a mapping application based on a local area network access point.

13. A mobile terminal as in claim 1, where the map is downloaded from a mapping application based on a location of the mobile terminal that is based on RF ID.

14. A software product for execution by a processor of a mobile terminal and comprising instructions stored on a processor readable medium, the instructions comprising those for implementing a location module coupled to a transceiver and responsive to a trigger to request that a map be downloaded to the mobile terminal for storage in a memory, said location module further coupled to a user interface for displaying at least a portion of a downloaded map to a user and for prompting the user to indicate the user's location on the map.

15. A software product as in claim 14, said location module being responsive to the user indicating the user's location for supplying enhanced mobile terminal location information to an application that requests mobile terminal location information.

16. A software product as in claim 14, where said trigger comprises a change in cell ID.

17. A software product as in claim 14, where said trigger comprises an output of anticipation logic.

18. A software product as in claim 14, where the map is downloaded from a mapping application that transforms between technology-specific location information and other location information.

19. A software product as in claim 14, where the map is downloaded from a mapping application that transforms between cell ID location information and Global Positioning System (GPS)-like coordinate information.

20. A software product as in claim 14, where the map comprises a vector map.

21. A software product as in claim 14, where the map is downloaded from a mapping application that requests the map from a cartography application.

22. A software product as in claim 14, where the map is downloaded over the Internet from a mapping application that requests the map over the Internet from a cartography application.

23. A software product as in claim 14, where the map is downloaded from a mapping application based on a current cell ID of the mobile terminal.

24. A software product as in claim 14, where the map is downloaded from a mapping application based on a predicted cell ID of the mobile terminal.

25. A software product as in claim 14, where the map is downloaded from a mapping application based on a local area network access point of the mobile terminal.

26. A software product as in claim 14, where the map is downloaded from a mapping application based on a location of the mobile terminal that is based on RF ID.

27. A method to operate a mobile terminal having a transceiver, comprising:
responsive to a trigger, operating a location module of the mobile terminal to request that a map be downloaded to the mobile terminal;
displaying at least a portion of a downloaded map to a user;
prompting the user to provide information related to the user's location relative to the map; and
using the provided information to enhance user location information that is provided to an application.

28. A method as in claim 27, further comprising:
responsive to the user providing the information, supplying enhanced mobile terminal location information to an application that requests mobile terminal location information.

29. A method as in claim 27, where said trigger comprises a change in cell ID.

30. A method as in claim 27, where said trigger comprises an output of anticipation logic.

31. A method as in claim 27, where the map is downloaded from a mapping application that transforms between technology-specific location information and other location information.

32. A method as in claim 27, where the map is downloaded from a mapping application that transforms between cell ID location information and Global Positioning System (GPS)-like coordinate information.

33. A method as in claim 27, where the map comprises a vector map.

34. A method as in claim 27, where the map is downloaded from a mapping application that requests the map from a cartography application.

35. A method as in claim 27, where the map is downloaded over the Internet from a mapping application that requests the map over the Internet from a cartography application.

36. A method as in claim 27, where the map is downloaded from a mapping application based on a current cell ID of the mobile terminal.

37. A method as in claim 27, where the map is downloaded from a mapping application based on a predicted cell ID of the mobile terminal.

38. A method as in claim 27, where the map is downloaded from a mapping application based on a local area network access point of the mobile terminal.

39. A method as in claim 27, where the map is downloaded from a mapping application based on a location of the mobile terminal that is based on RF ID.

40. A method to operate a mobile terminal having a transceiver, comprising:
responsive to a request from a location-based application, operating a location module of the mobile terminal to request, via the transceiver, that a position server provide information that is descriptive of a location of the mobile terminal;
in response to receiving the information, displaying at least a portion of a corresponding map to a user;
prompting the user to provide additional information related to the user's location relative to the map; and
using the provided information to enhance user location information that is provided to the location-based application.

41. A method as in claim 40, where the request is received through the transceiver.

42. A method as in claim 40, where the map is stored in a memory of the mobile terminal, and is downloaded via the transceiver.

43. A method as in claim 40, where the map is downloaded from a mapping application based on a current location of the mobile terminal.

44. A method as in claim 40, where the map is downloaded from a mapping application based on a predicted location of the mobile terminal.

45. A software product for execution by at least one data processor of a mobile terminal and comprising instructions stored on a processor readable medium, the instructions comprising those for performing operations of:
responsive to a request from a location-based application, operating a location module of the mobile terminal to request, via a transceiver, that a position server provide information that is descriptive of a location of the mobile terminal;
in response to receiving the information, displaying at least a portion of a corresponding map to a user;
prompting the user to provide additional information related to the user's location relative to the map; and
using the provided information to enhance user location information that is provided to the location-based application.

46. A mobile terminal comprising a wireless transceiver and a user interface coupled to a data processor operating under control of a stored program, said mobile terminal further comprising a location module coupled to a location based services (LBS) application and responsive to the LBS application to request, via said transceiver, that a network-based position server provide information that is descriptive of a location of the mobile terminal, said location module being operative in response to receiving the information to present at least a portion of the information to a user via the user interface and to prompt the user to provide additional information related to the user's location, said location module being responsive to the user providing additional information to supply enhanced user location information to the location-based application.

47. A mobile terminal as in claim 46, where said LBS application is resident in said mobile terminal.

48. A mobile terminal as in claim 46, where said LBS application is external to said mobile terminal.

49. A mobile terminal as in claim 46, where said location module is responsive to receiving the information that is descriptive of the location of the mobile terminal to forward, via said transceiver, the information to a mapping application, and to receive from said mapping application, via said transceiver, translated location information.

50. A mobile terminal as in claim 49, where said translated located information is in a human-understandable format.

51. A mobile terminal as in claim 49, where said translated located information is in a format required by said LBS application.

52. A mobile terminal, comprising a transceiver, a user interface and means, coupled to the transceiver and the user interface and responsive to a trigger, for requesting that map- related information be downloaded to the mobile terminal for storage in a memory, said requesting means further operable for causing said user interface to present at least a portion of downloaded map information to a user and to prompt the user to enter information related to the user's location relative to the presented map information for generating enhanced mobile terminal location information for use by at least one of a resident and a non-resident application.

53. A mobile terminal comprising a wireless transceiver and user interface means, said mobile terminal further comprising location means coupled to a location-based services (LBS) application and responsive to the LBS application for requesting, via said wireless transceiver, that a network-based position server provide information that is descriptive of a location of the mobile terminal, said location means operative in response to receiving the information for presenting at least a portion of the information to a user via said user interface means and for prompting the user, via said user interface means, to provide additional information related to the user's location, said location means being responsive to the user providing additional information for supplying enhanced user location information to the location-based application.
